(19) United States
(12) Patent Application Publication
(10) Pub. No.: US 2019/0101256 A1
(43) Pub. Date: Apr. 4, 2019

(54) Lamps and Illuminated Hardscapes

(71) Applicant: Hartman Design, Inc., Wernersville, PA (US)

(72) Inventor: Michael S. Hartman, Sinking Spring, PA (US)

(21) Appl. No.: 16/148,755

(22) Filed: Oct. 1, 2018

Related U.S. Application Data
(60) Provisional application No. 62/565,706, filed on Sep. 29, 2017.

(51) Int. Cl. F21S 8/00; F21V 23/06; F21V 21/30

(52) U.S. Cl. CPC F21S 8/036; F21W 2131/10; F21V 21/30; F21V 23/06

(57) ABSTRACT

A lighting system adapted for mounting on a hardscape structure formed from a plurality of discrete elements stacked one atop another, which lighting system includes a mount and a lamp having a body configured to be removably retained within the mount. The mount includes a first and second portions configured to be positioned at least in part between two or more of the discrete elements. The lamp includes a body that includes a plate configured to be receivable at least in part within the mount and removably retained therein between the first and second portions of the mount. The light fixture includes a light source and is coupled to the body.

### CROSS REFERENCE TO RELATED APPLICATIONS

This application is a non-provisional application of U.S. Provisional Application No. 62/565,706 filed Sep. 29, 2017, the disclosure of which is hereby incorporated herein by reference in its entirety.

### FIELD OF THE INVENTION

The disclosed embodiments relate to lighting for illuminating hardscape structures such as retaining walls.

### BACKGROUND OF THE INVENTION

Hard materials, such as masonry structures, used as a part of a landscape design are known commonly as “hardscapes.” A hardscape can incorporate structures such as pathways, steps, driveways, retaining walls and the like into an aesthetic installation generally, although not exclusively, in an outdoor setting which combines plant, masonry, and lighting elements to enhance the visual environment of a residence, commercial facility, or school campus, to cite but a few examples.

A hardscape may be formed of natural stone, bricks, or blocks manufactured from concrete, which are available in various colors, shapes and textures that simulate natural or quarried stone. Such products, for example, those provided by companies such as EP Henry of Woodbury, N.J., constitute structural systems that allow for the construction of structures such as retaining walls using discrete masonry elements that may be positioned atop one another to form a wall without the use of mortar. The structure, nevertheless, is a substantially permanent structure due to the weight, regular shape, friction and quasi-interlocking nature of the discrete elements.

Because lighting often is an important component of landscape design, it is desirable to incorporate lighting elements, such as lamps, into the design, and to provide the landscape designer with flexibility in configuring the lighting elements to produce an optimal lighting effect. Prior lamp designs for hardscape use are illustrated in U.S. Pat. No. 8,672,502, issued Mar. 18, 2014, the disclosure of which is incorporated herein it its entirety. While the devices shown therein have provided an improvement over prior devices, further improvements could provide added flexibility and control of the lighting effect, and better maintainability of the lamps.

### SUMMARY OF THE INVENTION

Embodiments of lamps adapted for mounting on a structure formed from a plurality of discrete elements stacked one atop another can include a body having a plate. The plate includes a first portion, a second portion, a top side, and an underside. The first portion is configured to be positioned between at least two of the elements so that contact between the first portion of the plate and the discrete elements retains the lamp in position on the structure. The plate has a length and a width each being substantially larger than a thickness of the plate between the top side and underside.

The lamps also include a light fixture having a light source coupled to the body adjacent to an underside of the second portion of the plate. In one form, the light source is configured to rotate in relation to the body.

Embodiments of illuminated hardscape structures include a first discrete element, a second discrete element positioned atop the first discrete element, and a lamp. The lamp includes a body having a plate with a first portion, a second portion, a top side, and an underside. The first portion is positioned between the first and second discrete elements so that contact between the first portion of the plate and the first and second discrete elements retains the lamp in position on the structure. The plate has a length and a width each being substantially larger than a thickness of the plate between the top side and underside.

The hardscape structures also include a light fixture having a light source. The light fixture is coupled to the body adjacent to an underside of the second portion of the plate, and is configured to rotate in relation to the body.

Embodiments of lighting systems adapted for mounting on a structure formed from a plurality of discrete elements stacked one atop another include a mount having a first portion with an upper surface and a lower surface, and a second portion with an upper surface and a lower surface. The lower surface of the first portion faces the upper surface of the second portion. The first and second portions are configured to be positioned at least in part between two or more of the discrete elements.

The lighting systems also include a lamp having a body with a plate. The plate has a top side; an underside; and a first portion configured to be positioned at least in part within the mount so that the lamp is retained in position on the mount between the first and second portions of the mount. The plate has a length and a width each being substantially larger than a thickness of the plate between the top side and underside.

The lamp also has a light fixture that includes a light source. The light fixture is coupled to the body.

The invention also provides a lighting system adapted for mounting on a structure formed from a plurality of discrete elements stacked one atop another, which lighting system includes a mount and a lamp having a body configured to be removably retained within the mount. The mount includes a first portion having an upper surface and a lower surface, and a second portion having an upper surface and a lower surface. The lower surface of the first portion faces the upper surface of the second portion, and the first and second portions of the mount are configured to be positioned at least in part between two or more of the discrete elements. The lamp includes a body that includes a plate having a top side an underside and a first portion configured to be receivable at least in part within the mount and removably retained therein between the first and second portions of the mount. The light fixture includes a light source and is coupled to the body.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a front-bottom perspective view of a lamp according to an exemplary embodiment of the invention, installed on a retaining wall and with a light fixture of the lamp located in a first position;

FIG. 2 is a bottom view of the lamp shown in FIG. 1, with the light fixture located in the first position;

FIG. 3 is a cross-sectional view of the lamp shown in FIGS. 1 and 2, taken along the line “3-3” of FIG. 1, with the light fixture located in the first position;

FIG. 4 is a cross-sectional view of the lamp shown in FIGS. 1 through 3, taken along the line “4-4” of FIG. 3, and depicting the light fixture in the first position and a second position;

FIG. 5 is a perspective view of an illuminated hardscape formed from the hardscape retaining wall and lamp shown in FIGS. 1 through 4;

FIG. 6 is a bottom view of a lighting system, with a lamp and a mount of the system in a mated condition, and depicting a light fixture of the lamp in a first position;

FIG. 7 is a top view of the lighting system shown in FIG. 6, with the lamp and the mount in a mated condition;

FIG. 8 is cross-sectional view of the lighting system shown in FIGS. 6-7, taken through the line “8-8” of FIG. 7, with the lamp and the mount in a mated condition, and depicting the light fixture in the first position;

FIG. 9 is cross-sectional view of the lighting system shown in FIGS. 6-8, taken through the line “9-9” of FIG. 7, with the lamp and the mount in a mated condition, and depicting the light fixture in the first position;

FIG. 10 is cross-sectional view of the lighting system shown in FIGS. 6-9 with the lamp and the mount in an unmated condition as the lamp is beginning to be inserted into the mount, and depicting the light fixture in the first position; and

FIG. 11 is a perspective view of an illuminated hardscape formed from a hardscape retaining wall incorporating the lighting system shown in FIGS. 6-10;

FIG. 12 is side view of the lighting system shown in FIGS. 6-11, installed in an illuminated hardscape in the form of a staircase; and

FIG. 13 is a perspective view of the staircase shown in FIG. 12.

### DETAILED DESCRIPTION OF THE EMBODIMENTS

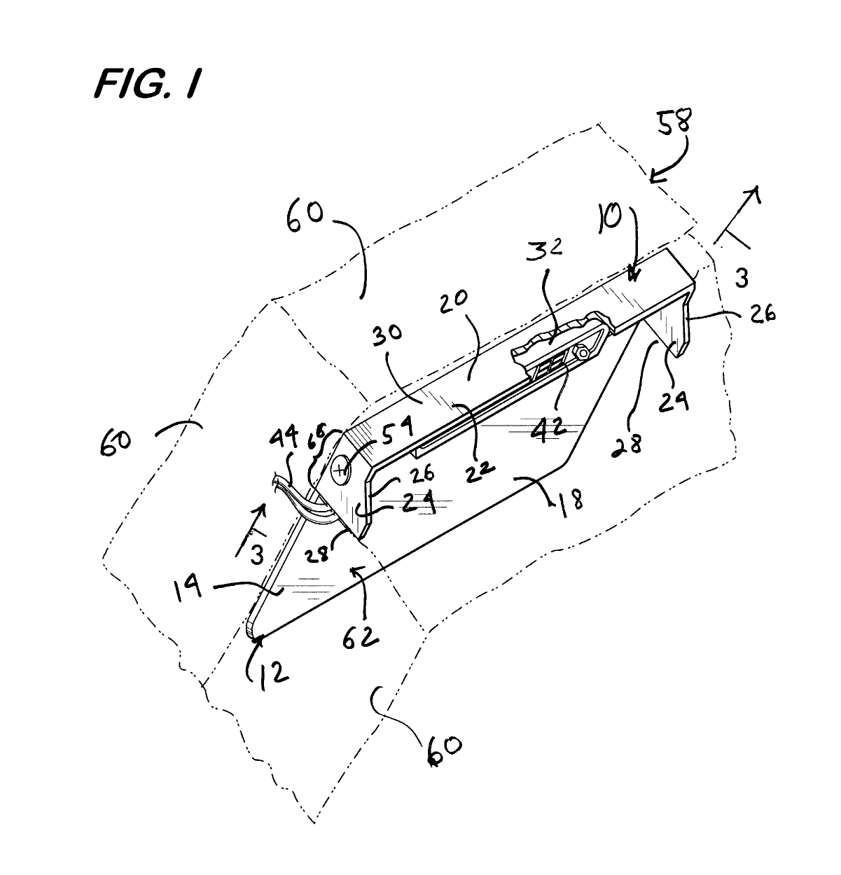

FIGS. 1-4 depict a lamp 10 capable of being integrated into a hardscape structure for illumination. The lamp 10 comprises a body 12. The body 12 includes a plate 14 having a top side 16 and an underside 18.

The body also includes a flange 20 attached to the plate 14. The flange 20 can be formed integrally with the plate 14, and can be bent or molded into the angular orientation shown in the figures. Alternatively, the flange 20 can be formed separately from the plate 14, and affixed to the plate 14 via mechanical, welding, or other suitable means. The flange 20 is preferable a substantially right angle flange, i.e., the flange is oriented substantially transverse to the underside 18 of the plate 14. The flange 20 can be oriented at virtually any angle relative to the plate 14 in alternative embodiments.

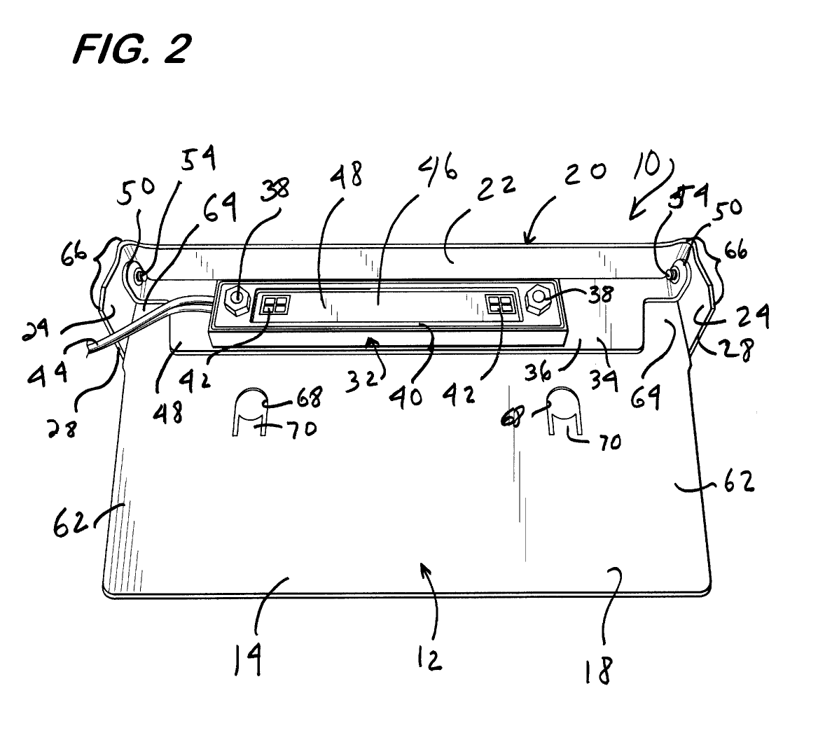

The flange 20 includes an elongated front panel 22 and side panels 24 as shown in FIGS. 1 and 2. The side panels 24 are attached to opposite ends of the front panel 22 and extend from the front panel 22 in a substantially transverse direction. The side panels 24 as illustrated are formed integrally with the front panel 22, although in alternative embodiments can be formed separately from the front panel 22. A portion of a lower edge 26 of each side panel 24 is angled downward, from the perspective of FIG. 4, so that each side panel 24 extends downward along a portion of its length. Each side panel has a side end 28 that can abut the hardscape blocks 60 as described below.

A decorative faceplate (not shown) can be attached to the body 12 in alternative embodiments. The faceplate can be configured to overlay an outwardly-facing surface 30 of the flange 20. The faceplate can be attached to the flange 20 via fasteners, such as screws; adhesives, brazing, and welding can be used in the alternative. It is advantageous to make the body 12 and the faceplate from robust materials such as metal that can withstand the effects of weather. Accordingly, the body 12 and faceplate may be formed, for example, from aluminum or stainless steel to prevent corrosion. If a decorative effect is desired, the body 12 and faceplate, or portions thereof, may be formed from, for example, copper or brass. Plastics and fiber reinforced composites can also be used, as well as a combination of metals, resins, plastics, synthetic stones, and other materials.

The lamp 10 further includes a light fixture 32, and a mounting bracket 34. The light fixture 32 is mounted on an elongated major portion 36 of the mounting bracket 34 using bolt and nut fasteners 38 as shown in FIG. 2. The light fixture 32 can be mounted using other suitable means, such as clips and adhesives, in the alternative.

The light fixture 32 includes a circuit board 40, a light source 42 mounted on the circuit board 40, and other electrical components for the light circuit as known in the art. The illustrated light source 42 is formed of two square arrays of LEDs having parallel circuitry, as shown in FIG. 2. Electrical wiring 44 is soldered to leads on the circuit board 40 to provide power to the light fixture 32. The light fixture 32 can be powered, for example, by 12-volt alternating current, and thus requires a transformer at the power source. The circuit board 40 and the light source 42 are preferably encased in a transparent shell 46 formed from plastic or other suitable materials. The shell 46 has a substantially planar major surface 48 through which the light produced by the light source 42 is primarily directed.

The above details of the light fixture 32 are presented for exemplary purposes only. The light fixture 32 can have other configurations in alternative embodiments. For example, alternative embodiments of the light fixture 32 can include less, or more than two arrays of LEDs; or can incorporate a light source other than LEDs, such as incandescent or halogen bulbs accommodated by one or more light sockets.

The mounting bracket 34 can be formed from a durable, rigid material suitable for outdoor use, such as stainless steel or aluminum. Plastics and fiber reinforced composites may also be used, as well as a combination of metals, plastics and other materials. The mounting bracket 34 has mounting tabs 50 that are attached to, and extend from opposing ends of the major portion 36, as shown in FIG. 2. The mounting tabs 50 are substantially L-shaped. The mounting tabs 50 are formed integrally with the major portion 36, and are bent or molded into the angular orientation shown in the figures. The mounting tabs 50 can have other shapes, and can be formed separately from the major portion 36 in alternative embodiments.

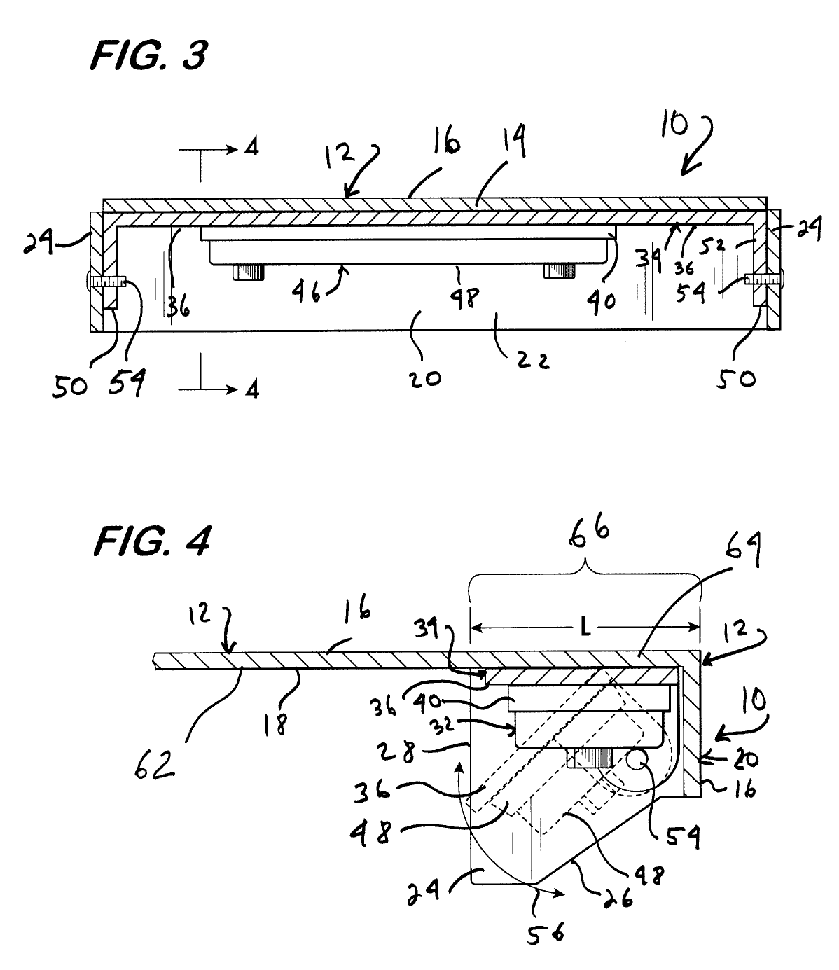

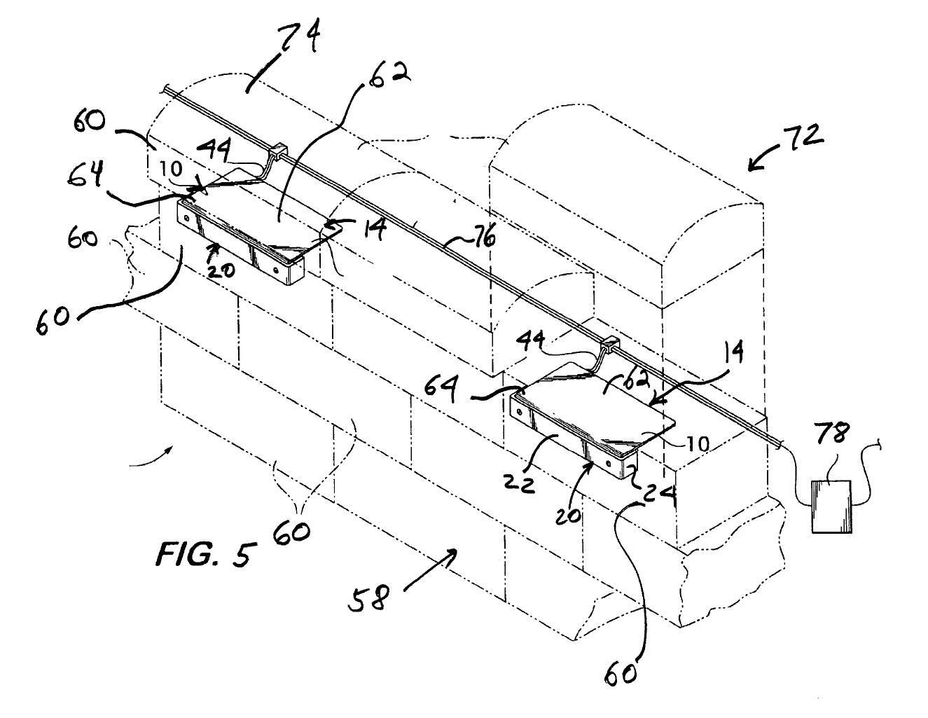

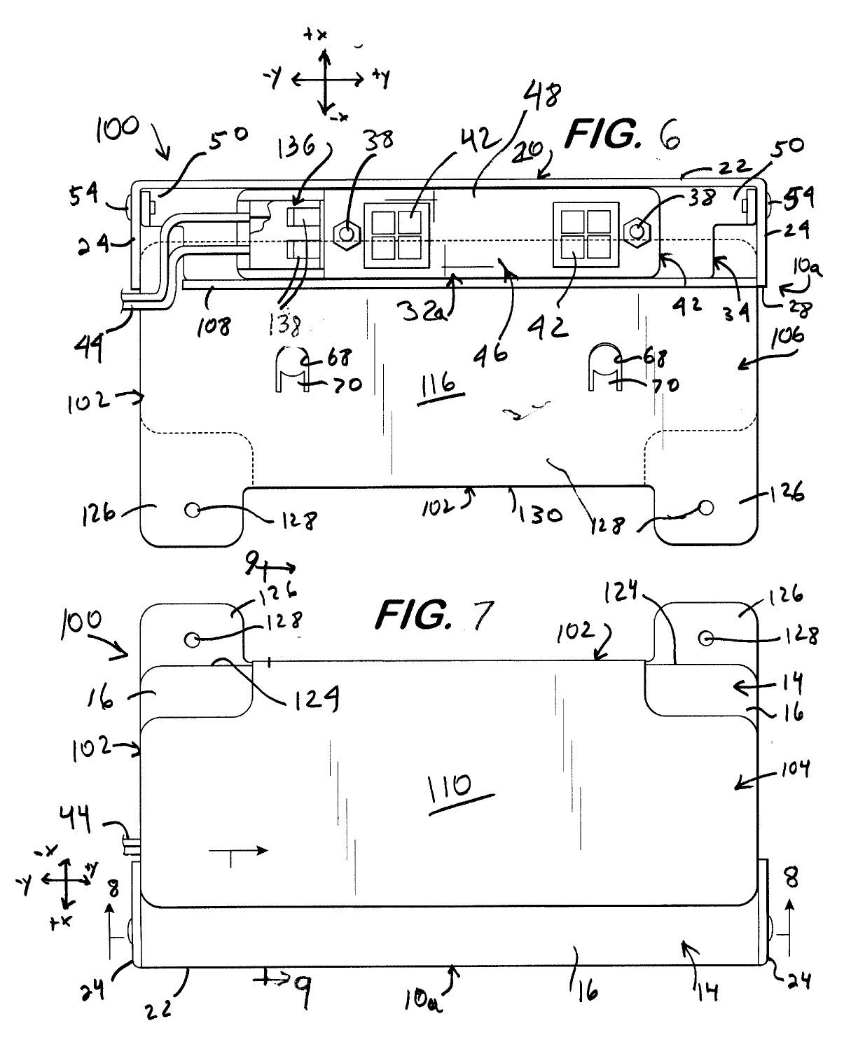

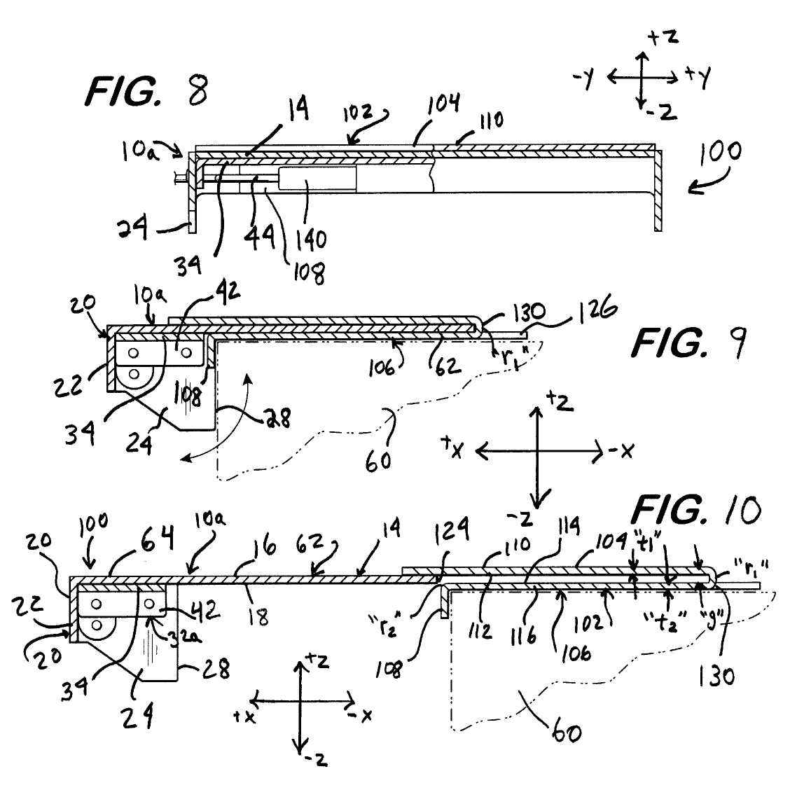

The mounting bracket 34 and the attached light fixture 32 are mounted for rotation relative to the body 12 by way of the mounting tabs 50. The mounting bracket 34 is sized so that an end portion 52 of each mounting tab 50 is located adjacent to an associated one of the side panels 24, and is spaced apart from the side panel 24 with minimal, or no clearance as shown in FIG. 3. Each mounting tab 50 is attached to the adjacent side panel 24 so as to be rotatable about a screw 54 that extends through the side panel 24, and engages threads formed on the end portion 52 of the mounting tab 50. Other means for attaching the mounting bracket 34 to the body 12, such as hinges, can be used in the alternative.

The mounting bracket 34 and the light fixture 32 can rotate between a first position depicted in solid lines in FIGS. 1 through 4, and a second position depicted in phantom lines in FIG. 4. The arrow 56 in FIG. 4 denotes the directions of rotation of the bracket 34 and the light fixture 32. As discussed below, this feature permits the angular position of the light fixture 32 to be adjusted so that the light emitted by the light source 42 can be aimed to change the area of illumination provided by the lamp 10. The lamp 10 is configured so that the mounting bracket 34 and light fixture 32 can undergo an angular displacement or rotation of approximately 45 degrees when moving between the first and second positions. Alternative embodiments of the lamp 10 can be configured so that the angular position of the mounting bracket 34 and light fixture 32 can undergo an angular displacement greater, or less than 45 degrees.

A user can adjust the area of illumination provided by the light fixture 32 by loosening the screws 54 to permit rotation of the mounting bracket 34, and then tightening the screws 54 once the mounting bracket 34 and the light fixture 32 have been rotated to a desired angular position. Alternatively, the mounting bracket 34 can be mounted with sufficient function to maintain whatever position it is in after being rotated to the desired angle, such as by use of a tight screw.

The front panel 22 and the side panels 24 of the flange 20 shield the light fixture 32 from view, at least partially, while permitting the light generated by the light fixture 32 to illuminate the area below the lamp 10. The angled orientation of the lower edge 26 of each side panel 24 helps to shield the light fixture 32 from view when the light fixture 32 is in, or near, its second position.

As shown in FIG. 1, the lamp 10 can be integrated into a hardscape structure such as a retaining wall 58, a portion of which is shown in phantom lines. The retaining wall 58 is formed from discrete block-like elements 60 positioned atop one another as illustrated. The lamp 10 is mounted on the retaining wall 58 by positioning a first portion 62 of the plate 14 of the lamp 10 between the block-like elements 60, as shown in FIG. 1. Preferably, the plate 14 is thin enough, and the elements 60 are sufficiently coarse to prevent the presence of the plate 14 from significantly affecting the stacking of the elements 60. The lamp 10 can be retained in the wall 58 by contact between the plate 14 and the block-like elements 60, and without the use of separate fasteners. The side ends 28 of the side panels 24 abut the face of the block element 60 to properly space the light fixture 32 therefrom. The lamp 10 is positioned with a second portion 64 of the plate 14 which defines a projection portion 66 projecting from the wall 58 (here defined by the side ends 28) so that the front panel 22 of the flange 20 is spaced from the adjacent surface of the associated element 60 as shown in FIG. 1. This provides a space between the flange 20 and the adjacent surface of the block element 60 for the light fixture 32. It is seen that the length L of the side panels 24 can fix the length of the projection portion. Openings 68 having a retainer tab 70 positioned therein can be provided. The openings 68 can be used to engage mortar if used, and the retention tabs 70 can be bent or angled downwardly to engage the hardscape surface and help retain the lamp 10 in place.

FIG. 5 shows an illuminated hardscape 72 constructed retaining wall 58, and a plurality of the lamps 10 mounted thereon. The lamps 10 are mounted to the retaining wall 58 by positioning the plates 14 between discrete block-like elements 60 as the elements 60 are stacked atop one another to form the hardscape 72. No special tools are required, and the components of the lamp are readily accessible for repair or replacement, providing significant ease of maintenance. An element 60 formed as a top or cap block 74 can extend outwardly to cover the projection portion 66 of the lamp 10. Power lines 44 extend from the lamps 10 and are connected via a bus 76 or wires 44 to a power source, such as a transformer 78, which steps 110-volt household electrical service to a low voltage typically used with outdoor lighting systems. Although the plates 14 are shown oriented horizontally in the wall 58, a vertical orientation is also feasible by positioning each plate 14 within the vertical seam between two adjacent block-like elements 60. The lamp 10 can also be used with steps formed with hardscape blocks 60, whereby the plate 14 would preferably be positioned between a riser block and a tread block (further described below).

The ability to rotate the light fixture 32 permits a user to aim the light generated by the light fixture 32 so as to produce a desired visual effect on the hardscape 72 and the surrounding area. For example, when the light fixture 32 is in the first position depicted in solid lines in FIGS. 1-4, the light produced by the light source 42 is directed primarily downward, with the front panel 22 and the side panels 24 of the flange 20 helping to direct the light downwardly along the retaining wall 58 and shielding the light from a person whose eyes are well above the lamp 10. Thus, this configuration will produce a wash effect on the retaining wall 58. If it is desired to provide greater illumination to the area in front of the retaining wall 58, for example, to illuminate landscaping or other features near the wall 58, the mounting bracket 34 and the light fixture 32 can rotated toward, or to, the second position shown in phantom lines in FIG. 4. Changing the angular position of the light fixture 32 in this manner will cause more of the light to be directed at the area in front of the wall 58, with less of the light washing downwardly along the wall 58.

The lamps disclosed herein provide a simple and elegant illumination for hardscape design that is easy to install and maintain. Such lamps are readily removable and repositionable and facilitate repair or reconfiguration of the hardscape as required. They may be used with any form of hardscape, for example, concrete products such as blocks or bricks, natural stone, mortared or stacked structures, wooden structures such as decks and retaining walls made from railroad ties to cite but a few exemplary applications. The ability to adjust and aim the light fixtures of the lamps provides added flexibility in optimizing the spread of the light produced by the lamps for aesthetic, safety-related, or other purposes.

In addition to being used on a stand-alone basis as described above, the lamps 10, and variants thereof, can be incorporated into a lighting system 100 as depicted in FIGS. 6-13. The lighting system 100 can include a lamp 10a, and a mount 102 configured to hold the lamp 10a.

The lamp 10a is substantially identical to the lamp 10 as described above, with the exception of the manner in which the power line 44 of the lamp 10a is connected to the light fixture 32, which is discussed below. Components of the lamp 10a that are identical, or substantially identical to those of the lamp 10 are denoted herein, and in the drawings, by identical reference characters. The use of the lamp 10a in connection with the lighting system 100 is disclosed for exemplary purposes only. The lighting system 100 can be equipped with other types of lamps that are capable of mating with the mount 102 in the below described manner, including the lamp 10, and lamps that do not have a rotatable light fixture such as those shown in the U.S. Pat. No. 8,672,502. In addition, the lamp 10a can be used on a stand-alone basis, i.e., without the mount 102.

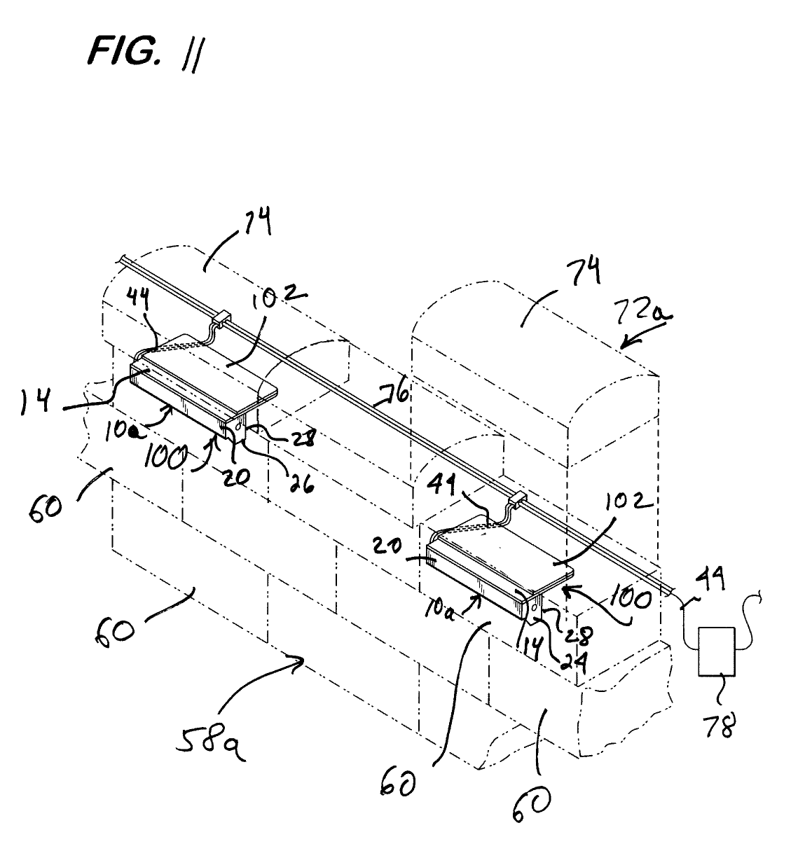

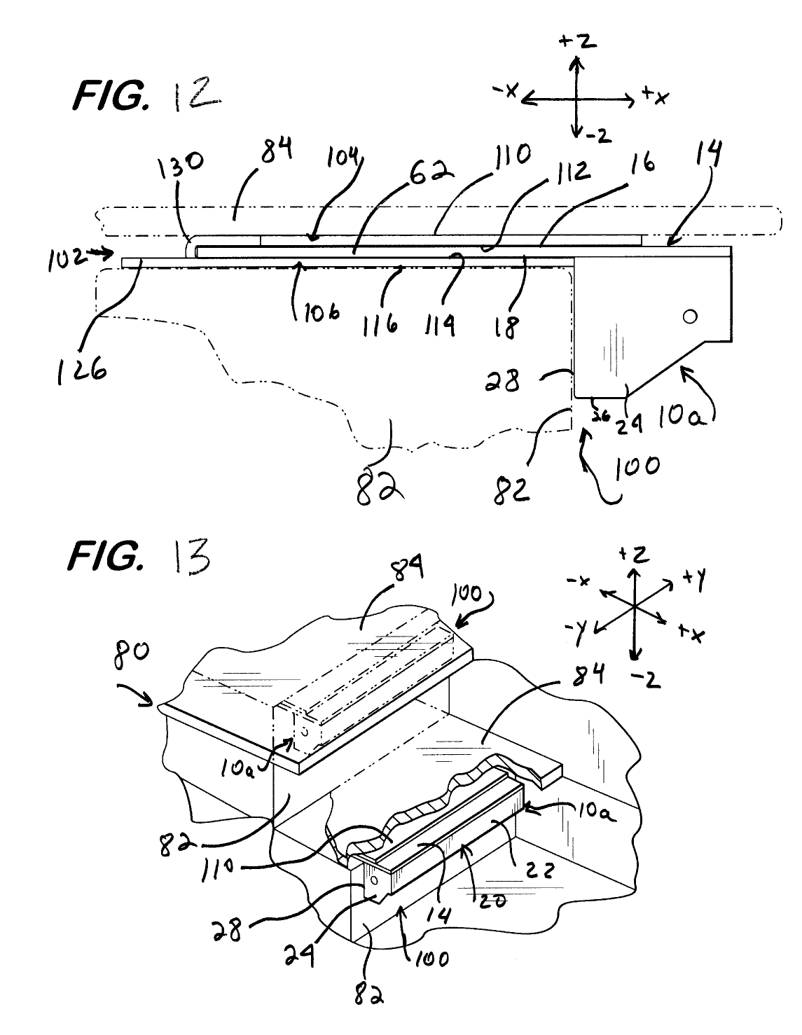

The mount 102 is configured to be mounted between two or more of the discrete block-like elements 60 of a hardscape structure such as a retaining wall 58a shown in FIG. 11, on steps 80 depicted in FIGS. 12 and 13. The mount 102 is configured to receive the plate 14 of the lamp 10a as shown, for example, in FIGS. 9 and 12. Friction between the mount 102 and the plate 14 retains the lamp 10a in the mount 102. In addition, the configuration of the mount 102 facilitates removal and reinstallation of the lamp 10a without any disassembly of the retaining wall 58a or the steps 80. FIGS. 6-9 and 11-13 depict the lamp 10a and the mount 102 in a mated condition; FIG. 10 depicts the lamp 10a and the mount 102 in an unmated condition.

Referring to FIGS. 6-10 and 12, the mount 102 comprises a first portion 104, a second portion 106, and a lip 108. The first portion 104 has a substantially planar upper surface 110, and a substantially planar lower surface 112 separated by a relatively small thickness “t₁” of the first portion 104, giving the first portion 104 a plate-like configuration. The second portion 106 likewise has a substantially planar upper surface 114, and a substantially planar lower surface 116 separated by a relatively small thickness “t₂” of the second portion 106, giving the second portion 106 a plate-like configuration. The first portion 104 is positioned above the second portion 106 from the perspective of FIGS. 9 and 10, so that at least a portion of the lower surface 112 of the first portion 104 is adjacent to and faces the upper surface 114 of the second portion 106.

The lip 108 extends downwardly from a forward edge of the second portion 106, from the perspective of FIGS. 9 and 10, in a direction substantially perpendicular to the plane of the upper surface 114 of the second portion 106. Alternative embodiments can be formed without the lip 108.

The second portion 106 includes two tabs 126, as depicted in FIGS. 6 and 7. The tabs 126 are located on opposite sides of the second portion 106, and form part of the rearward edge of the second portion 106. Each tab 126 has a hole 128 formed therein. The holes 128, as explained below, can receive fasteners or adhesive that secure the second portion 106 to the discrete block-like elements 60 upon which the mount 102 is positioned.

The mount 102 can be formed from a durable, rigid material suitable for outdoor use, such as stainless steel or aluminum, and should be sufficiently resilient to hold the plate 14 in place. Suitable plastics and fiber reinforced composites may also be used, as well as a combination of metals, plastics and other materials. The mount 102 can be unitarily formed, i.e., the mount 102 can be formed from a single sheet of material which can be bent so as to define a folded, or third portion 130 that adjoins the first portion 104 and the second portion 106. In addition, the sheet can be folded along a fold line 132 to form the lip 120. Cutouts can be formed in the sheet before it is bent to define the tabs 124.

The bending of the sheet to form the lip 108 results in a relatively small radius “r₂” between the lip 108 and the second portion 106, as can be seen in FIG. 10. As discussed below, this radius helps to guide the lamp 10a into position between the first portion 104 and the second portion 106.

The third portion 130 is substantially C-shaped, and has a radius “r₁” as shown in FIGS. 9, 10, and 12. The radius r₁, in conjunction with the resilience of the material from which the sheet is formed, cause the third portion 130 to act as a spring-loaded hinge that urges the first and second portions 104, 106 towards one another, e.g., urges the freestanding end of the first portion 104 downward, so that the lower surface 112 of the first portion 104 is urged toward, and preferably into partial contact with the upper surface 114 of the second portion 106. It should be noted that the surface 112 of the first portion 104 is shown in FIG. 10 as not contacting the upper surface 114 of the second portion 106, because the plate 14 of the lamp 10a is urging the first portion 104 upward, against its bias, as the lamp 10a is being inserted into the mount 102. The radius r₁ is chosen to define a gap, designated by the dimension “g” in FIG. 10, between the first and second portions 104, 106. The gap g is sized to receive and hold the plate 14, i.e., the gap g is approximately the same size as, or slightly larger than, the thickness of the plate 14 to create a friction fit for holding the lamp 10a therein.

The first portion 62 of the plate 14 is received between the first portion 104 and the second portion 106 of the mount 102, as shown in FIGS. 9 and 12. The first portion 104 and the second portion 106 of the mount 102 each have a width, or “y” dimension, approximately equal to the width of the first portion 62 of the plate 14. The depth, or “x” dimensions of the first portion 104 and the second portion 106 each are selected so that the rearward, or free end 124 of the first portion 62 preferably is located at, or proximate the third portion 130 when the lamp 10a has been fully inserted into the mount 102 as shown in FIGS. 9 and 12, i.e., when the rearward-facing ends of the side panels 24 of the lamp 10a abut the retaining wall block 60 or other structure on which the mount 102 is positioned.

Once the first portion 62 of the plate 14 has been inserted into the mount 102, the lower surface 112 of the first portion 104 and the upper surface 114 of the second portion 118 are urged toward the respective top side 16 and underside 18 of the first portion 62, due to the bias of the third portion 130 on the first and second portions 104, 106, and may also be urged by the weight of the retaining wall or other structure located above the mount 102. The lamp 10a is retained in the mount 102 by the resulting friction between the top side 16 of the first portion 62 of the plate 14 and the lower surface 112 of the first portion 104 of the mount 102; and between the underside 18 of the first portion 62 of the plate 14 and the upper surface 114 of the second portion 106 of the mount 102.

The lamp 10a includes a light fixture 32a, shown in FIG. 6. The light fixture 32a can be substantially identical to the light fixture 32 of the lamp 10, but preferably includes a connector 136 that permits the power line 44 to be readily disconnected and reconnected to the light fixture 32. The connector 136 of the illustrated embodiment includes two receptacles that mate with the respective positive and negative leads on the power line 44. The connector 136 also includes spring-loaded clamps 138 that permit each lead to be mated and de-mated with its corresponding receptacle by depressing the clamp manually to eliminate the clamping action, and releasing the clamp after the lead has been inserted or removed, to restore the clamping force. The connector 136 is sealed within the transparent shell 46 of the light fixture 32a, making the connector 136 waterproof (the shell 46 is configured to permit access to the receptacles by the positive and negative leads on the power line 44).

The lighting system 100 can be integrated into a hardscape structure such as an illuminated hardscape 72a formed from a retaining wall 58a shown in FIG. 11. As noted above in relation to the retaining wall 58 described above, the retaining wall 58a is formed from discrete block-like elements 60 positioned atop one another. The lighting system 100 is mounted on the retaining wall 58a by positioning the mount 102 between the block-like elements 60. Preferably, the mount 102, with the lamp 10a positioned therein, is thin enough, and the elements 60 are sufficiently coarse to prevent the presence of the mount 102 from significantly affecting the stacking of the elements 60.

The mount 102 can be installed on the retaining wall 58a preferably as the retaining wall 58a is being constructed. Installation is performed by placing the mount 102 on top of one (or more) of the block-like elements 60 whose upper surface coincides with the desired height for the lamp system 100, so that the lower surface 116 of the second portion 106 rests on the upper surface of the block-like element 60 and the lip 108 abuts the outwardly-facing surface of the block-like element 60.

The mount 102 can be secured to the underlying block-like element 60 using fasteners (not shown) anchored to the element 60 by way of the holes 128 formed in the tabs 126. Alternatively, the mount 102 can be secured using adhesive placed, for example, on and under the tabs 126, and within the holes 128. Once the mount 102 has been secured and the power line 44 for the light fixture 32a has been routed through the adjacent block-like elements 60 to the earth or fill behind the blocks 60, another of the block-like elements 60, such as a top or cap block 74, can be placed on top of the mount 102, so that the bottom surface of the block-like element 60 rests on the upper surface 110 of the first portion 104 of the mount 102. When installing the overlying block-like element 60, the lamp 10a should be fully inserted in the mount 102 as shown in FIG. 9, so that sufficient space is present between the lower surface 112 of the first portion 104 and the upper surface 114 of the second portion 106 to permit removal and reinstallation of the lamp 10a at a later time. The lamp 10a is positioned in the mount 102 such that the side ends 28 of each side panels 24 abut or are adjacent the block 60 as shown.

Once the retaining wall 58a has been completed, the mount 102 is retained on the retaining wall 58a by fasteners through the tabs 126, mortar, and/or friction between the mount 102 and the adjacent block-like elements 60.

Alternatively, the mount 102 and lamp 10a can be retrofitted into the retaining wall 58a after the retaining wall 58a has been constructed. The mount 102, with the lamp 10a inserted therein, can be inserted between two or more of the block-like elements 60, until the lip 108 of the mount 102 abuts the block-like element or elements 60 located directly below the mount 102.

The mount 102 also can be integrated into a hardscape structure such as a staircase 80a shown in FIGS. 12 and 13. In such an application, the mount 102 can be positioned between, and retained by a step riser 82 and a tread 84 of the staircase 80, with the flange 20 of the lamp 10a being located completely under the portion of the tread 84 that overhangs the riser 82. The use of the lighting system 100 in connection with the retaining wall 58a and the staircase 80 is disclosed for exemplary purposes only; the lighting system 100 can be used in connection with other types of structures.

The configuration of the mount 102 permits the lamp 10a to be removed from, and reinstalled in the retaining wall 58a and the staircase 80 quickly and easily, without any disassembly of the retaining wall 58a or the staircase 80. To remove the lamp 10a, the user merely needs to pull the lamp 10a away from the retaining wall 58a or the staircase 80, so as to overcome the friction between the contacting surfaces of the mount 102 and the first portion 62 of the plate 14, at which point the first portion 62 can be slid out from between the first portion 104 and the second portion 106. The power line 44 can be disconnected in the above-discussed manner before the lamp 10a is pulled away from the mount 102 to avoid disturbing the power line 44, which is permanently routed within or along the retaining wall 58a in a typical installation.

To reinstall the lamp 10a, or a new lamp 10a, the user places the free end of the first portion 62 of the plate 14 between the first portion 104 and the second portion 106, and pushes the lamp 10a inwardly, i.e., toward the retaining wall 58a or the staircase 80. The curvature between the lip 108 and the second portion 106 resulting from the radius r₂ may help to guide the end of the first portion 62 between the first portion 104 and the second portion 106, and encourages the first portion 104 to separate from the second portion 106 to accommodate the plate 14 therebetween. The lamp 10a is pushed inwardly until the rearward-facing ends of the side panels 24 of the lamp 10a abut the retaining wall 58a or the staircase 80. Further inward movement is preferably prohibited at this point by interference between the side panels 24 and the retaining wall 58a or staircase 80. The power line 44 can be reconnected in the above-discussed manner before or after the lamp 10a has been inserted into the mount 102 depending on the configuration of the wire.

The use of the mount 102 thus permits the lamp 10a to be repaired or replaced without any disassembly of the retaining wall 58a or the staircase 80a. In addition, the ability to disconnect the light fixture 32a from the power line 44 makes it possible to replace the light fixture 32a with disturbing the power line 44 from its installed position within or along the retaining wall 58a or the staircase 80.

1-20. (canceled)

21: A lighting system adapted for mounting on a structure formed from a plurality of discrete elements stacked one atop another, the lighting system comprising:
a mount comprising a first portion having an upper surface and a lower surface, and a second portion having an upper surface and a lower surface, wherein the lower surface of the first portion faces the upper surface of the second portion, and the first and second portions of the mount are configured to be positioned at least in part between two or more of the discrete elements; and
a lamp, comprising:
a body comprising a plate having a top side an underside and a first portion configured to be receivable at least in part within the mount and removably retained therein between the first and second portions of the mount wherein the plate has a length and a width each being substantially larger than a thickness of the plate between the top side and underside; and
a light fixture comprising a light source, the light fixture being coupled to the body.

22: The lighting system of claim 21, wherein the light fixture is mounted beneath the underside of the plate.

23: The lighting system of claim 22, wherein the plate further includes a second portion, the light fixture is mounted beneath the second portion of the plate, and the body further comprises a flange that extends downwardly from an edge of the second portion of the plate.

24: The lighting system of claim 21, wherein the mount further comprises a third portion that adjoins the first and second portions of the mount.

25: The lighting system of claim 24, wherein the third portion is substantially C-shaped.

26: The lighting system of claim 24, wherein the third portion is configured to urge the first portion of the mount into contact with the second portion of the mount.

27: The lighting system of claim 24, wherein the third portion is configured to resiliently deflect when the first portion of the plate is positioned at least in part within the mount.

28: The lighting system of claim 21, wherein the second portion of the mount includes a tab configured to be secured to at least one of the discrete elements.

29: The lighting system of claim 21, wherein the upper surface and the lower surface of the first portion of the mount are substantially planar, and the upper surface and the lower surface of the second portion of the mount are substantially planar.

30: The lighting system of claim 21, wherein the upper surface of the second portion of the mount is substantially planar and the mount further comprises a lip that extends from an edge of the second portion of the mount in a direction substantially perpendicular to the plane of the second portion of the upper surface.

31: The lighting system of claim 21, wherein the light fixture further comprises a connector electrically connected to the light source, the connector being configured to be electrically connected to a power line on a selective basis.

32: The lighting system of claim 21, wherein the mount is retained in position on the structure by contact between at least one of the discrete elements and the upper surface of the first portion, and by contact between at least one other of the discrete elements and the lower surface of the second portion.

33: The lighting system of claim 21, wherein the lamp is retained in position on the mount by contact between the lower surface of the first portion of the mount and the top side of the body, and by contact between the upper surface of the second portion of the mount and the underside of the body.

34: The lighting systems of claim 21, wherein the light fixture is configured to rotate in relation to the lamp plate.

35: An illuminated hardscape structure comprising:
a first discrete element and a second discrete element positioned atop the first discrete element; and
a lighting system comprising
a mount comprising a first portion having an upper surface and a lower surface, and a second portion having an upper surface and a lower surface, wherein the lower surface of the first portion faces the upper surface of the second portion, and the first and second portions of the mount are positioned at least in part between said first and second discrete elements; and
a lamp comprising a body, said body includes a plate having a top side, an underside and a first portion configured to be receivable at least in part within the mount and removably retained therein between the first and second portions of the mount; and
a light fixture comprising a light source, said light fixture being coupled to the body.

36: An illuminated hardscape structure in accordance with claim 35 wherein said first and second discrete elements comprise a step riser and a tread.

37: The lighting system of claim 35, wherein the light fixture is mounted beneath the underside of the plate.

38: The lighting system of claim 37, wherein the plate further includes a second portion, the light fixture is mounted beneath the second portion of the plate, and the body further comprises a flange that extends downwardly from an edge of the second portion of the plate.

39: The lighting system of claim 35, wherein the mount further comprises a third portion that adjoins the first and second portions of the mount.
